(19) United States
(12) Patent Application Publication
(10) Pub. No.: US 2007/0154654 A1
(43) Pub. Date: Jul. 5, 2007

(54) Optical compensator film with controlled birefringence dispersion

(75) Inventors: Jehuda Greener, Rochester, NY (US); James F. Elman, Fairport, NY (US); Tomohiro Ishikawa, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/321,135

(22) Filed: Dec. 29, 2005

(51) Int. Cl. C09K 19/00

(52) U.S. Cl. 428/1.1

(57) ABSTRACT

Disclosed is an optical film with controlled birefringence dispersion that is useful in the field of display and other optical applications. The optical film comprises at least a plurality of negative birefringence polymeric layers and a plurality of positive birefringence polymeric layers, wherein each layer is independently 200 nm or less in thickness and the negative birefringent layers alternate with the positive birefringent layers.

### FIELD OF THE INVENTION

This invention relates to an optical film with controlled birefringence dispersion. The films of the present invention are useful in the field of display and other optical applications. More particularly the invention relates to an optical film comprising at least a plurality of negative birefringence polymeric layers and a plurality of positive birefringence polymeric layers, wherein each layer is independently 200 nm or less in thickness.

### BACKGROUND OF THE INVENTION

Liquid crystals are widely used for electronic displays. In these display systems, a liquid crystal cell is typically situated between a polarizer and analyzer. Incident light polarized by the polarizer passes through a liquid crystal cell and is affected by the molecular orientation of the liquid crystal, which can be altered by the application of a voltage across the cell. The altered light goes into the analyzer. By employing this principle, the transmission of light from an external source, including ambient light, can be controlled.

Contrast, color reproduction, and stable gray scale intensities are important quality attributes for electronic displays, which employ liquid crystal technology. The primary factor limiting the contrast of a liquid crystal display (LCD) is the propensity for light to“leak” through liquid crystal elements or cells, which are in the dark or“black” pixel state. The contrast of an LCD is also dependent on the angle from which the display screen is viewed. One of the common methods to improve the viewing angle characteristic of LCDs is to use compensation films. Birefringence dispersion is an essential property in many optical components such as compensation films used to improve the liquid crystal display image quality. Even with a compensation film, the dark state can have undesirable color tint such as red or blue, if the birefringence dispersion of the compensation film is not optimized.

A material that displays at least two different indices of refraction is said to be birefringent. In general, birefringent media are characterized by three indices of refraction, nₓ, n_{y}, and n_{z}. The out-of-plane birefringence is usually defined by Δnₜₕ=n_{z}−(nₓ+n_{y})/2, where nₓ, n_{y}, and n_{z} are indices in the x, y, and z direction, respectively. Correspondingly, the in-plane birefringence is defined as Δnᵢₙ=|nₓ−n_{y}|. The retardation is simply the product of the birefringence and the thickness of the film (d). Thus, the out-of-plane retardation, Rₜₕ, is defined as: d Δnₜₕ, and the in-plane retardation Rᵢₙ is defined as: d Δnᵢₙ.

In a standard compensation scheme, all of OCB (optical compensated birefringence)-, VA (vertically aligned)- and IPS (in-plane switching)-type LCDs require Rᵢₙ that is more positive than 40 nm at a wavelength λ=550 nm. The value and the sign desirable for Rₜₕ depend on the LCD mode as well as on the thickness and optical characteristics of the liquid crystal cell used. Generally, OCB, VA and STN-type LCD's require negative Rₜₕ that is more negative than−80 nm, while IPS-type LCD compensation requires positive Rₜₕ above 50 nm at λ=550 nm.

Indices of refraction are functions of wavelength (λ). Accordingly, the Δnₜₕ and Rₜₕ , as well as the Δnᵢₙ and Rᵢₙ also depend on λ. Such a dependence of birefringence on λ is typically called birefringence dispersion. Birefringence dispersion is an essential property in many optical components such as compensation films used to improve the liquid crystal display image quality.

Adjusting Δnₜₕ dispersion, along with in-plane birefringence (nₓ−n_{y}) dispersion, is critical for optimizing the performance of compensation films. In the past, Rₜₕ and Rᵢₙ have been optimized at one wavelength λ, (e.g λ=550 nm). Therefore, while a film compensates LCD well at particular λ, it does not perform in a satisfactory manner over the entire spectrum of light. This leads to color shift of the dark state of the display.

Dispersion control of the retardation values are necessary as the phase of propagating light is proportional to Rᵢₙ/λ or Rₜₕ/λ. Optical properties of the LC material also influence the dispersion requirement. The Δnₜₕ can be negative (102) or positive (104) throughout the wavelength of interest, as shown in FIG. 1. In most cases, a film made by casting polymer having positive intrinsic birefringence, Δnᵢₙₜ, gives negative Δnₜₕ. Its dispersion is such that the Δnₜₕ value becomes less negative at longer wavelength (102). On the other hand, by casting polymer with negative Δnᵢₙₜ, one obtains a positive Δnₜₕ value with less positive Δnₜₕ value at longer wavelength (104). The dispersion behavior, in which the absolute value of Δnₜₕ decreases with increasing wavelength, is called“normal” and the film is normal-dispersive.

In general, it is desirable to have Δnₜₕ essentially constant over the visible wavelength (λ) range (between 400 nm and 650 nm) (curves 106 and 108 in FIG. 1). Hereinafter, the term“essentially constant” means that for at any two wavelengths λ₄≠λ₅ such that 400 nm<λ₄,λ₅<650 nm, we have 0.95<|Δnₜₕ(λ₄)|/|Δnₜₕ(λ₅)|<1.050. Particularly useful media are ones having low and constant Δnₜₕ satisfying |Δnₜₕ(λ)|<0.0001 for wavelength λ satisfying 400 nm<λ<650 nm (curve 110 in FIG. 1). Thus, such media exhibit essentially zero birefringence. In still other cases, it is desirable for the absolute value of Δnₜₕ to increase at longer wavelength. Such behavior is called“reverse” dispersion (curves 202, 204 in FIG. 2) and the film is said to be reverse-dispersive.

The wavelength dispersion for Rₜₕ , or Δnₜₕ, can be expressed in terms of a dispersion parameter DP as,
DP=Rₜₕ(450 nm)/Rₜₕ(590 nm)=Δnₜₕ(450 nm)/Δnₜₕ(550 nm).
When DP>1 the dispersion is said to be“normal” while when DP<1 it is “reversed” and the material is“reverse-dispersive”. A similar quantity can also be defined for Rᵢₙ. The reverse dispersion in Rᵢₙ (Δnᵢₙ) is advantageous for minimizing color shift in OCB, VA and IPS compensators. However, the preferred dispersion and the sign of Rₜₕ (Δnₜₕ) differs among the different LCD modes. For OCB and VA, it is preferred to have negative Rₜₕ (Δnₜₕ) with DP>1. This is because the dark state of these two modes is approximated by the vertically aligned liquid crystal molecules with positive Rₜₕ. The dispersion of the liquid crystal is usually normal. IPS-type LCD requires positive Rₜₕ (Δnᵢₙ) with DP<1. In IPS-type LCD, the compensation is essentially equivalent to that of the crossed polarizers requiring the combination of positive Rᵢₙ and positive Rₜₕ, both having reverse dispersion. If the dispersion behavior is not optimized, color shift of the dark state will occur. Dispersion control of the retardation values is necessary as the phase of propagating light is proportional to Rᵢₙ/λ or Rₜₕ/λ.

The various types of Δnₜₕ responses can be achieved in principle by coating two or more layers on a substrate with the corresponding materials having suitable difference in dispersion of Δnₜₕ. Such a coating approach, however, may be difficult to implement, as one has to carefully adjust the thickness of each layer, and the materials used in this approach must be highly birefringent and are usually very costly. The production cost is also increased by the addition of extra coating steps to the manufacturing operation.

U.S. Pat. No. 6,565,974 discloses a method for controlling birefringence dispersion by means of balancing the optical anisotropy of the main chain and side chain groups of a polymer. This method teaches that through a careful balance of the repeat units (monomers) of the polymer it is possible to achieve lower birefringence (or retardation) at shorter wavelength, i.e., produce a reverse-dispersive material. Such a material is inherently weakly birefringent, requiring coating relatively thick layers to attain sufficiently high levels of retardation as required in most compensation schemes. Thus, compensation films made by this method will be relatively costly and not readily suitable for low cost (consumer) applications.

### PROBLEM TO BE SOLVED BY THE INVENTION

Accordingly, it would be desirable to develop a method for controlling the Δnₜₕ dispersion by producing a transparent polymeric film with a suitable combination of birefringence and dispersion characteristics. It is also desirable that such a combination of properties be achieved by utilizing low-cost materials rather than expensive specialty polymers to prepare the compensation film. It would be further desirable to prepare a C-plate, or a biaxial plate, with the desired dispersion and retardation characteristics, for use in a liquid crystal display device.

### SUMMARY OF THE INVENTION

It is an object of the invention to obtain films having the property of reverse dispersion in Δnₜₕ and equivalent retardation components. It is another object of the invention to obtain films having an essentially flat dispersion property in Δnₜₕ , and equivalent Rₜₕ components. It is another object of the invention to obtain films having normal and reverse dispersion in Δnₜₕ.

This invention provides an optical film comprising at least a plurality of negative birefringence (N) polymeric layers and a plurality of positive birefringence (P) polymeric layers, wherein each layer is 200 nm or less in thickness. In one aspect of the invention, a multi-layered optical compensation film comprises a plurality of layers of alternating compositions, e.g., N/P/N/P . . . and the like, where each layer (N, P) comprises a different amorphous polymeric material. The layers must be sufficiently thin (<200 nm) to assure light transmission through the multi-layered composite film structure and the polymeric materials must possess inherent birefringence levels that are opposite in sign. The total number of layers preferably exceeds 50 to achieve a generally desired final film thickness of >10 μm. By adjusting the relative thicknesses of layers N and P and by selecting amorphous polymers with the right levels of absolute birefringence but with opposite signs, it is possible to construct multi-layered film structures with the right dispersion and sign requirements in Rₜₕ,. This, in combination with proper Rᵢₙ, can be used to optimize the optical performance of the LCD.

The N layers preferably comprise a polymer having a Δnₜₕ more negative than −0.002 and the P layers preferably comprise a polymer having an Δnₜₕ more positive than +0.002. The overall magnitude of the overall Rₜₕ of the film is preferably more negative than −20 nm while the Rᵢₙ could be adjusted over the range 0 -100 nm. When the overall Δnₜₕ of the film is less negative than −4.0×10⁻³ it is possible to achieve flat or reverse birefringence dispersion while attaining Rₜₕ of up to 300 nm. This embodiment allows the use of inexpensive polymers to yield a low-cost compensation film having the desired dispersion property.

More particularly, one embodiment is directed to a multi-layered film comprising a large plurality of alternating layers (n>50) of N and P polymers. Layers N comprise a negatively birefringent polymer N and layers P comprise a positively birefringent polymer P such that the total Rₜₕ produced by 0.5n N layers and 0.5n P layers is given by:
Rₜₕ=0.5n(d_{N}Δn_{th,N}+dₚΔn_{th,P})

And the total thickness of the film is:
d=0.5n(d_{N}+dₚ)

Where d_{N} and Δn_{th,N} are the average thickness and birefringence of layers N, and dₚ and Δn_{th,P} are the average thickness and birefringence of layers P. Similar expressions can be derived for the Rᵢₙ of the multi-layered film. According to the present invention, flat or reverse birefringence dispersion is achieved by keeping the average Δnₜₕ of the multi-layered film, Δnₜₕ=Rₜₕ/d, to be less negative than −4.0×10⁻³. This particular birefringence level can be attained through selection of polymers N and P with appropriate birefringence levels, Δn_{th,N} and Δn_{th,P}, and by adjusting the final layer thicknesses d_{N} and d_{P} in the coextrusion process used to prepare the multi-layered compensation film.

### BRIEF DESCRIPTION OF THE DRAWINGS

The embodiments are best understood from the following detailed description when read with the accompanying drawing figures. It is emphasized that the various features are not necessarily drawn to scale. In fact, the dimensions may be arbitrarily increased or decreased for clarity of discussion.

FIG. 1 is a graph showing various birefringence dispersion behaviors, including positive and negative out-of-plane dispersion and essentially constant dispersion and normal dispersion;

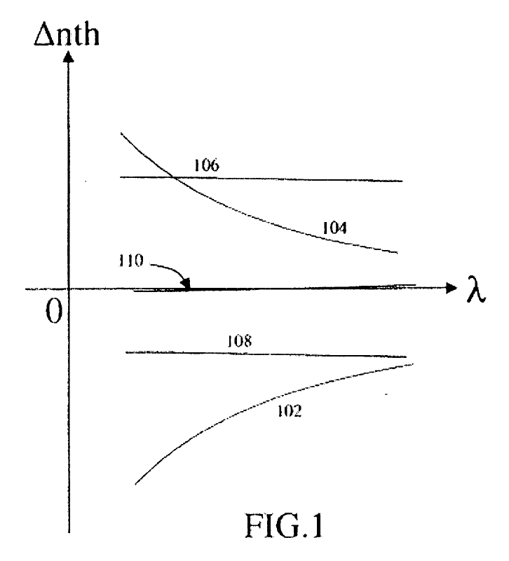

FIG. 2 is a graph showing positive and negative Δnₜₕ exhibiting reverse dispersion behavior;

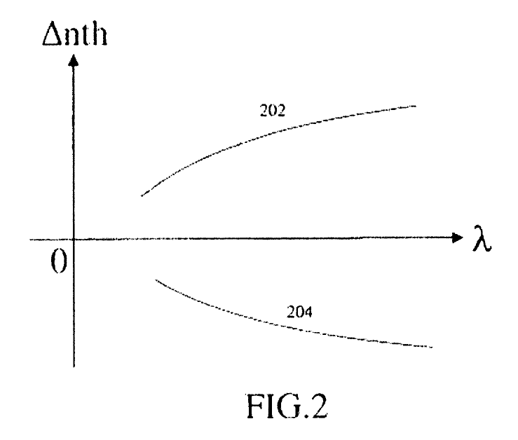

FIG. 3 illustrates an exemplary film having a thickness d and dimensions in the“x”, “y,” and“z” directions in which x and y lie perpendicularly to each other in the plane of the film, and z is normal to the plane of the film; FIG. 4A shows a polymeric film in which the polymer chains have a statistically averaged alignment direction;

FIG. 4B shows a polymeric film in which the polymer chains are randomly oriented but statistically confined in the x-y plane of the film;

FIG. 5 is a schematic cross-section of the inventive multilayered film.

### DETAILED DESCRIPTION OF THE INVENTION

The invention has been described with reference to preferred embodiments. However, it will be appreciated that variations/modifications of such embodiments can be affected by a person of ordinary skill in the art without departing from the scope of the invention.

As mentioned above, the present invention provides materials having desired birefringence behavior. The invention can be used to form a flexible optical film that has high optical transmittance or transparency and low haze. In a preferred embodiment the optical films of the invention are compensation films for use in liquid crystal displays. In another embodiment the compensation films of the invention may be employed as polarizer protective films. Such films can be manufactured utilizing low-cost polymers. These and other advantages will be apparent from the detailed description below.

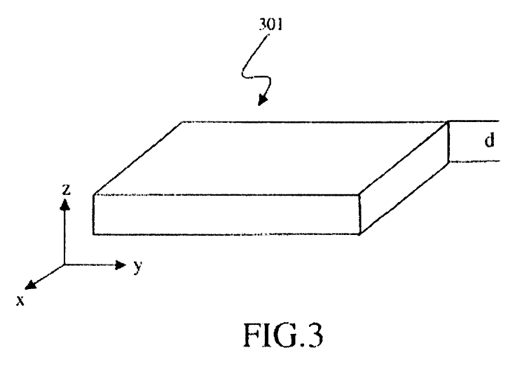

With reference to FIG. 3, the following definitions apply to the description herein:

The letters“x,” “y,” and“z” define directions relative to a given film (301), where x and y lie perpendicularly to each other in the plane of the film, and z is normal the plane of the film.

The term“optic axis” refers to the direction in which propagating light does not see birefringence. In polymer material, the optic axis is parallel to the polymer chain.

The terms“nₓ, ” “n_{y}, ” and “n_{z}” are the indices of refraction of a film in the x, y, and z directions, respectively. A“C-plate” refers to a plate or a film in where nₓ=n_{y}, and n_{z} that differs from nₓ and n_{y}. Usually, when materials are solvent-cast or melt-cast into a film, the film possesses the property of a C-plate.

The term“intrinsic birefringence” (Δnᵢₙₜ) of a given polymer refers to the quantity defined by (nₑ−nₒ), where nₑ and nₒ are the extraordinary and ordinary index of the polymer molecular chain, respectively. Intrinsic birefringence of a polymer is determined by factors such as the polarizabilities of functional groups and their bond angles with respect to the polymer chain. Indices of refraction nₓ, n_{y}, and n_{z} of a polymer article, such as a film, are dependent upon manufacturing process conditions of the article and Δnᵢₙₜ of the polymer.

The term“out-of-plane retardation” (Rₜₕ ) of a film is a quantity defined by [n_{z}−(nₓ+n_{y})/2]d, where d is the thickness of the film 301 shown in FIG. 3. The quantity [n_{z}−(nₓ+n_{y})/2] is referred to as the“out-of-plane birefringence” (Δnₜₕ ). The values given hereinafter correspond to λ=550 nm.

The term“in-plane birefringence” with respect to a film 301 is defined by |nₓ−n_{y}|. The corresponding in-plane retardation Rᵢₙ is defined by Rᵢₙ=|nₓ−n_{y}|d. The values given hereinafter correspond to λ=550 nm.

The term“amorphous” means a lack of long-range molecular order. Thus, an amorphous polymer does not show long-range order as measured by techniques such as X-ray diffraction.

The term“dispersion parameter” (DP) of a film is defined by
DP=Δnₜₕ(450 nm)/Δnₜₕ(590 nm).

Identical definition can be made based on the corresponding retardation component.

For a polymeric material, the indices nₓ, n_{y}, and n_{z} result from the Δnᵢₙₜ of the material and the process of forming the film. Various processes, e.g., casting, stretching and annealing, give different states of polymer chain alignment. This, in combination with Δnᵢₙₜ, determines nₓ, n_{y}, n_{z}. Generally, solvent-cast polymer film exhibits small in-plane birefringence (<1×10⁻⁴ at λ=590 nm). However, depending on the processing conditions and the polymer type, Δnₜₕ can be considerably higher.

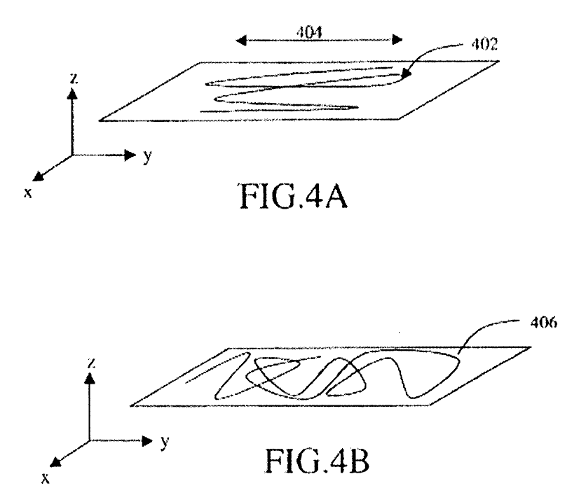

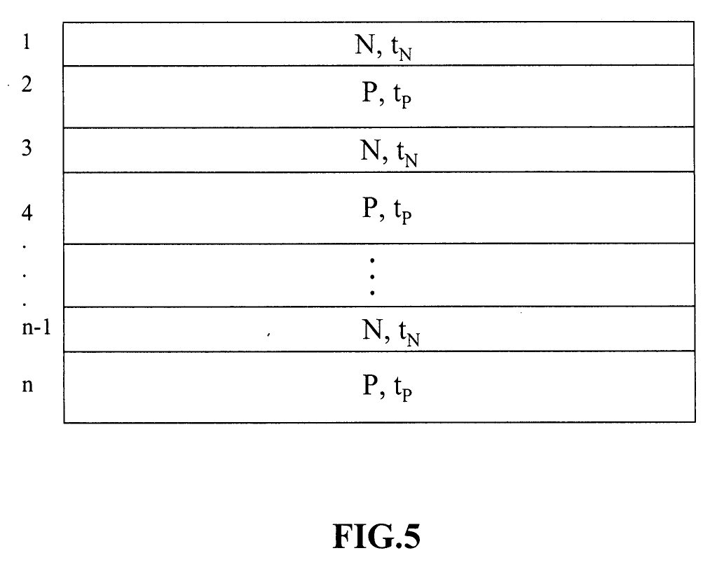

The mechanism of generating Δnₜₕ can be explained by using the concept of the order parameter, S. As is well known to those skilled in the art, the out-of-plane birefringence of the polymer film is given by Δnₜₕ=S Δnᵢₙₜ. As mentioned above, Δnᵢₙₜ is determined only by the properties of the polymer, whereas the process of forming the film fundamentally controls S. Usually 0≦|S |≦1, if the polymer chains (402) in a polymeric film have a statistically averaged alignment direction (404), as shown in FIG. 4A. On the other hand S takes a negative value, if the polymer chains (406) in the film are randomly oriented but are statistically confined to the x-y plane, as shown in FIG. 4B. For example, solvent or melt casting of polymers can generate such a random in-plane orientation. In this case, we have two indices of refraction, nₓ and n_{y}, that are essentially equal due to the randomness of the in-plane alignment (x-y plane in FIG. 3). However, n_{z} will differ since the polymer chain is more or less confined in the x-y plane. In order to obtain negative Δnₜₕ , polymers having positive Δnᵢₙₜ are used, while for positive Δnₜₕ , ones with negative Δnᵢₙₜ are employed. In both cases, we have the property of a C-plate having nₓ≈n_{y}. In the multi-layered film of the present invention, shown in FIG. 5, the order parameter of layers N and P, S_{N} and S_{P}, are essentially identical (S_{N}≈S_{P}≈S) because they involve a similar process history but the Δnᵢₙₜ, values of polymers N and P are different so that the average birefringence and retardation of the film are given by
Rₜₕ=d Δnₜₕ=0.5n S(d_{N}Δn_{int,N}+dₚΔn_{int,P})
To achieve a flat or reverse dispersion (DP≦0) the invention prescribes that Δnₜₕ is less negative than −4.0×10⁻³ and Δn_{int,N} and Δn_{int,P} have opposite signs. Since Δnₜₕ is relatively low it is necessary to increase the thickness of the film or the total number of layers sufficiently to achieve a desired level of Rₜₕ useful in a compensation scheme for liquid crystal display.

For the purpose of the present invention the layers comprising polymers N and P should have a thickness of 200 nm or less. Preferably each layer should be less than 150 nm and most preferably less than 100 nm thick. Typically the thickness of the optical film comprising the plurality of N and P layers is about 10 to 200 micrometers thick. If the thickness of the film is less than 20 micrometers, general handling and conveyance of such a film can be problematic and produce various optical and physical defects. Thickness greater than 200 micrometers is not desirable due to space considerations in the polarizer assembly of the LCD.

To obtain the desired birefringence behavior the optical film of the invention should comprise at least 50 total layers. Preferably the optical film should comprise at least 1000 total layers and most preferably at least 2000 total layers. The Δnₜₕ of the N or P layers must be sufficiently high (preferably more negative than −0.002 or more positive than +0.002) to produce the desirable effect of reverse dispersion and contribute to the overall retardation of the film.

The term“chromophore” is defined as an atom or group of atoms that serve as a unit in light adsorption. (Modem Molecular Photochemistry, Nicholas J. Turro, Ed., Benjamin/Cummings Publishing Co., Menlo Park, Calif. (1978), p. 77).

Typical chromophore groups for use in the polymers of the present invention include vinyl, carbonyl, amide, imide, ester, carbonate, aromatic (i.e., heteroaromatic or carbocylic aromatic groups such as phenyl, naphthyl, biphenyl, thiophene, bisphenol), sulfone, and azo or combinations thereof. A“non-visible chromophore” is one that has an absorption maximum outside the range of λ=400-700 nm.

The orientation of the chromophore relative to the optical axis of a polymer chain determines the sign of Δnᵢₙₜ. If placed along the main chain, the Δnᵢₙₜ of the polymer will be positive and, if the chromophore is placed off the main chain, relatively perpendicular to the main chain axis, the Δnᵢₙₜ of the polymer will be negative. As mentioned hereinabove, in order to obtain negative Δnₜₕ, polymers having positive Δnᵢₙₜ are used, while for positive Δnₜₕ, ones with negative Δnᵢₙₜ are employed Examples of polymers suitable for use in the positive birefringence polymeric layers include materials having non-visible chromophores off of the polymer backbone. Such non-visible chromophores, for example, include: vinyl, carbonyl, amide, imide, ester, halogen, carbonate, sulfone, azo, and aromatic heterocyclic and aromatic carbocyclic groups (e.g., phenyl, naphthyl, biphenyl, terphenyl, phenol, bisphenol A, and thiophene). In addition, combinations of these non-visible chromophores may be desirable (i.e., in copolymers). Examples of such polymers and their structures are poly(methyl methacrylate), poly(4 vinylbiphenyl) (Formula I below), poly(4 vinylphenol) (Formula II), poly(N-vinylcarbazole) (Formula III), poly(methylcarboxyphenylmethacrylamide) (Formula IV), polystyrene, styrene-acrylonitrile copolymers, poly[(1-acetylindazol-3-ylcarbonyloxy)ethylene](Formula V), poly(phthalimidoethylene) (Formula VI), poly(4-(1 -hydroxy-1 -methylpropyl)styrene) (Formula VII), poly(2-hydroxymethylstyrene) (Formula VIII), poly(2-dimethylaminocarbonylstyrene) (Formula IX), poly(2-phenylaminocarbonylstyrene) (Formula X), poly(3-(4-biphenylyl)styrene) (XI), and poly(4-(4-biphenylyl)styrene) (XII),

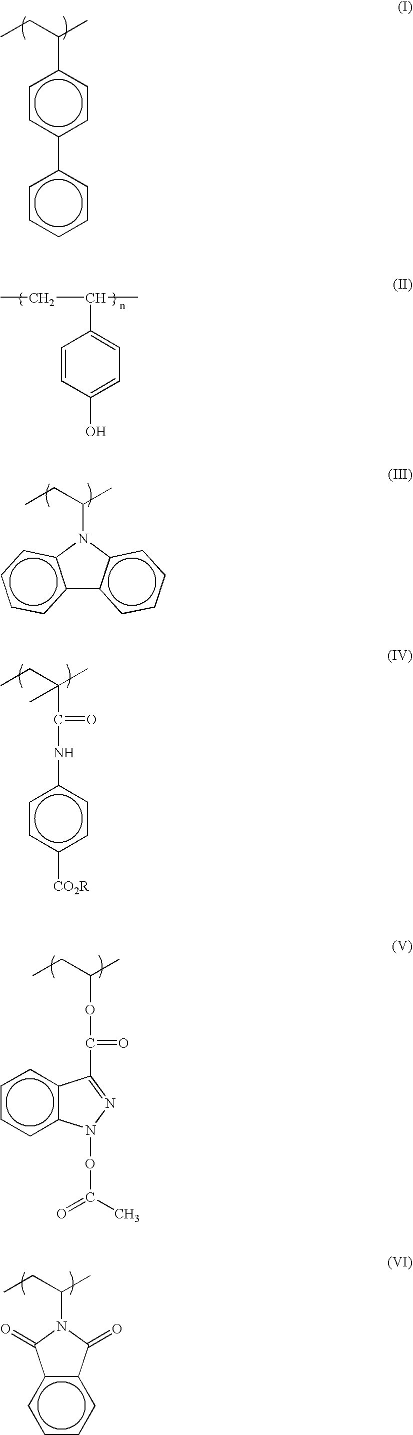

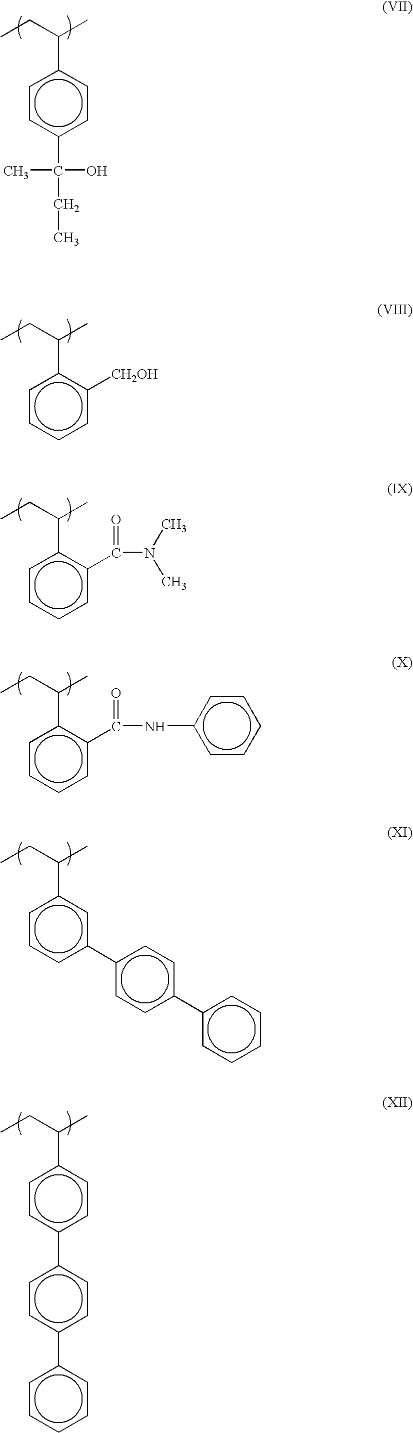

Examples of polymers suitable for use in the negative birefringence polymeric layers include materials that have non-visible chromophores on the polymer backbone. Such non-visible chromophores, for example, include: vinyl, carbonyl, amide, imide, ester, halogen, carbonate, sulfone, azo, and aromatic heterocyclic and aromatic carbocyclic groups (e.g., phenyl, naphthyl, biphenyl, terphenyl, phenol, bisphenol A, and thiophene). In addition, polymers having combinations of these non-visible chromophores may be desirable (i.e., in copolymers). In addition, blends of two or more polymers having non-visible chromophores on the polymer backbone may be employed. Examples of polymers useful in the negative birefringence polymeric layers are polyesters, polycarbonates, polysulfones, polyphenylene oxides, polyarylates, polyketones, polyamides, and polyimides containing, for example, the following monomers:

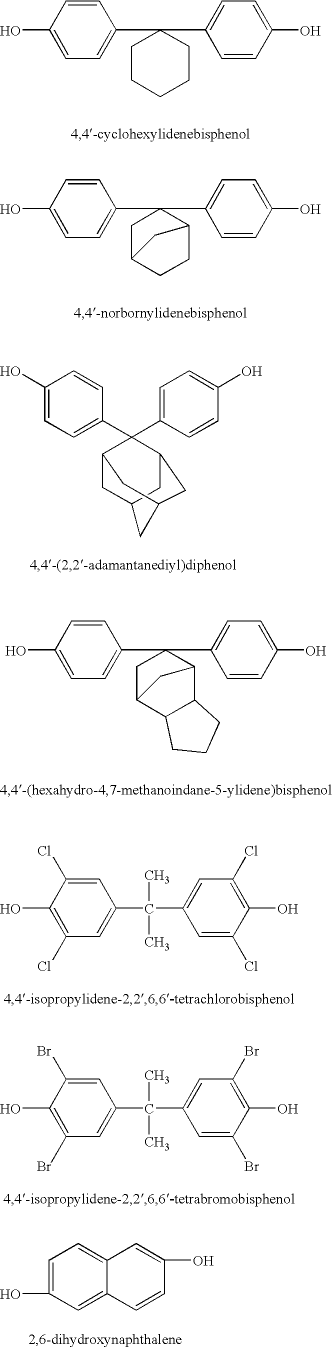

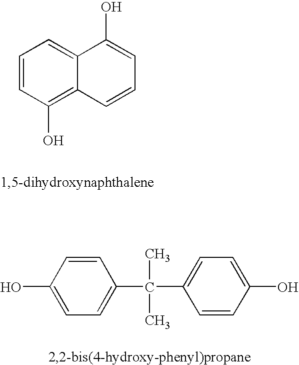

The following table (Table 1) lists several optical polymers and their intrinsic birefringence (Δnᵢₙₜ) values:

TABLE 1

| Polymer | Δnᵢₙₜ |
|---|---|
| Polystyrene | −0.100 |
| Poly(phenylene oxide) | +0.210 |
| Bis-phenol A polycarbonate | +0.106 |
| Poly(methyl methacrylate) | −0.0043 |
| Poly(ethylene terephthalate) | +0.105 |

The intrinsic birefringence is often difficult to measure for a given polymer so, for estimation purposes, it is possible to replace this quantity with the inherent birefringence (Δnᵢₙₕ), which is easily determined. This property is the value of the out-of-plane birefringence (at λ=590 nm) of a thin film (3-8 μm) of the polymer cast from 10% (by wt) solution of the polymer in a relatively volatile solvent. Some representative values of Δnᵢₙₕ for several optical polymers are shown in Table 2.

TABLE 2

| | Δnᵢₙₕ* |
|---|---|
| Polymer | (×10³) |
| Polystyrene | +4.6 |
| Bis-phenol A polycarbonate | −12 |
| Poly(styrene co (acrylonitrile)) | +3.9 |
| Poly(methyl methacrylate) | +0.35 |
| Poly(vinyl carbazole) | +30 |
| Polysulfone | −12 |

*The signs of Δnᵢₙₕ and Δnᵢₙₜ are opposite because of different sign conventions.

The values in Table 2 can be used to design a multi-layered compensator with the requisite Rₜₕ and dispersion characteristics. For an alternating N/P/N/P/. . .-type structure the general design formula for obtaining a birefringent film with flat or reverse dispersion is given by:
Rₜₕ=0.5 n(d_{N}Δn_{inh,N}+dₚΔn_{inh,P})

When Rₜₕ<0.0 and 3×10⁻³<|(Rₜₕ/d)|<4×10⁻³ →DP˜1.0 (“flat dispersion”).

When Rₜₕ<0.0 and |(Rₜₕ/t)<3×10⁻³ →DP<1.0(“reverse dispersion”).

The nano-layer coextrusion process for making the multi-layered compensator is described in detail in U.S. Pat. Nos. 3,557,265; 3,656,985 and 3,773,882 to Schrenk et al. Essentially, the process involves melt coextrusion of two or more materials to produce a multi-layered film using an appropriate coextrusion feedblock-type die (or similar) and a series of layer multiplication elements. In one particular embodiment the two polymers (N and P) are melt-extruded through two (or more) dedicated extruders into a common feedblock die, which converts the two melt streams into a two-layered N/P sheet. This layered sheet is then passed in sequence through k layer multiplication elements whereupon passage through each element the number of layers is doubled. The total number of layers depends on k and it follows the formula: n=2^{(k+l)}. Thus, to produce a film with approximately 1000 layers, 9 multiplication elements are needed. A similar process is described in U.S. Pat. No. 5,882,774 and 2005/0105191 (A1) to produce multi-layered structures for other specialized optical applications. U.S. Pat. No. 5,882,774 to Jonza et al., describes a method for producing flexible mirrors and recycling polarizers. These applications require a specific combination of the refractive indices of the corresponding material pairs to be effective. US Patent Application 2005/0105191 A1 to Baer et al. teaches a method for making gradient-index lenses comprising a multi-layered coextrusion step of the type described in U.S. Pat. Nos. 3,557,265; 3,656,985 and 3,773,882. Here, the multi-layered coextrusion process is used to produce self-supporting films with a range of refractive indices, which are then stacked, fused and polished to form a flat gradient-index lens.

If a finite level of Rᵢₙ is desired to achieve effective compensation, the film of the present invention must undergo a stretching step whereby the film is stretched uniaxially or biaxially, subsequent to the coextrusion film-making step, using a tenter frame or another stretching method well known to those skilled in the art. The stretching step requires, typically but not exclusively, raising the temperature of the film above the glass transition temperature (Tg) of the layer with the highest Tg {i.e, T_{stretch}>max [Tg_{N}, Tg_{P}]}. The stretching can be performed along the machine direction or along the cross-direction with or without constraining the film edges. The stretching can be done in both directions to produce biaxial orientation. This biaxial stretch can be performed sequentially or simultaneously. In one embodiment of the invention, the optical film has an Rᵢₙ of from 0 to 300 nm, preferably 20 to 200 nm, and most preferably from 25 to 100 nm. In another or the same embodiment the optical film has an Rₜₕ of from -300 to +300 nm, preferably from −200 to +200 nm, and more preferably from −100 to +100 nm.

Preferably the optical film of the present invention has a DP based on Rᵢₙ of from 0.3 to 1.0. More preferably the DP of the film is from 0.7 to 1.0. The optical film of the present invention also preferably has a DP based on Rₜₕ of from 0.3 to 1.0. More preferably the DP based on Rₜₕ of the film is from 0.7 to 1.0.

The particular values Rᵢₙ and Rₜₕ and the corresponding dispersion parameters depend on the particular polarizer assembly and LC cell and must be optimized for contrast ratio and color shift in any specific case. This invention teaches a general method for controlling both the retardation level and the dispersion parameter using a nano-layered film produced by a special melt co-extrusion process.

It should be understood that in addition to a two-material alternating film structure of the N/P/N/P type, as described above, it is possible to employ three-material structures of the following types: N/P/A/N/P/A/. . . , N/A/P/A/N/A/P/A/. . . etc., where material A may be positively-birefringent, negatively-birefringent or non-birefringent. Structures with more materials are possible in principle but the cost of preparing such many-material multi-layered film structures could be prohibitive and may not provide an obvious benefit.

The following examples illustrate the practice of this invention. They are not intended to be exhaustive of all possible variations of the invention. Parts and percentages are by weight unless otherwise indicated.

### EXAMPLES

The values in Table 2 were used to design multi-layered compensators, Examples 1 to 3, with the requisite Rₜₕ and dispersion characteristics. For an alternating N/P/N/P/. . .-type structure the general design formula for obtaining a birefringent film with flat or reverse dispersion is given by:
Rₜₕ=0.5n(d_{N}Δn_{inh,N}+dₚΔn_{inh,P})

When Rₜₕ<0.0 and 3×10⁻³<|(Rₜₕ/d)|<4×10⁻³ →DP˜1.0(“flat dispersion”).

When Rₜₕ<0.0 and |(Rₜₕ/t)|<3×10⁻³ →DP<1.0 (“reverse dispersion”).

A multilayered film comprising alternating polycarbonate and polystyrene layers can be prepared using the nano-layer coextrusion method described in U.S. Pat. Nos. 3,557,265; 3,656,985 and 3,773,882. In the following prophetic examples, the out-of-plane birefringence, Δnₜₕ at 590 nm, and the birefringence dispersion, as expressed by the parameter DP=Δnₜₕ (450 nm)/Δnₜₕ(590 nm), can be measured using a WOOLLAM-2000V Spectroscopic Ellipsometer.

### EXAMPLE 1-3

Polystyrene (PS) and polycarbonate (PC) resins are used to form an alternating PC/PS/PC/PS. . . nano-layer film comprising altogether 1024 layers. This structure is formed by the nano-layered coextrusion method using 9 layer multiplication elements. In Examples 1 -3 the thicknesses of the PC and PS layers are adjusted to have different values as shown in Table 3.

### COMPARATIVE EXAMPLE 1

The same process is repeated but the layer thicknesses are adjusted such that the absolute value of Δnₜₕ of the multi-layered film is greater than 4.0×10⁻³. The result for this case is also listed in Table 3 below.

TABLE 3

| | d_{PS} | d_{PC} | d | Rₜₕ | Δnₜₕ | |
|---|---|---|---|---|---|---|
| | (nm) | (nm) | (μm) | (nm) | (×10³) | DP |
| Example 1 | 108 | 58 | 85 | −102 | −1.2 | 0.9 |
| Example2 | 65 | 70 | 69 | −276 | −4.0 | ˜1.0 |
| Example 3 | 100 | 50 | 77 | −72 | −0.9 | 0.85 |
| Comp. Example 1 | 65 | 70 | 69 | −362 | −5.2 | 1.10 |

It is seen from the results in Table 3 that when the Δnₜₕ of the multi-layered film is more negative than 4.0×10⁻³ the film exhibits normal dispersion. Otherwise, if the Δnₜₕ is equal to or less negative than 4.0×10⁻³ the film exhibits reverse or essentially flat dispersion.

The invention has been described in detail with particular reference to certain preferred embodiments thereof, but it will be understood that variations and modifications can be effected within the spirit and scope of the invention.

1. An optical film comprising at least a plurality of negative birefringence polymeric layers and a plurality of positive birefringence polymeric layers, wherein each layer is 200 nm or less thick.

2. The optical film of claim 1 wherein the negative birefringence polymeric layers alternate with the positive birefringence polymeric layers.

3. The optical film of claim 1 wherein each layer is 150 nm or less.

4. The optical film of claim 1 wherein each layer is 100 nm or less.

5. The optical film of claim 1 comprising at least 50 layers.

6. The optical film of claim 1 comprising at least 1000 layers.

7. The optical film of claim 1 comprising at least 2000 layers.

8. The optical film of claim 4 comprising at least 1000 layers.

9. The optical film of claim 4 comprising at least 2000 layers.

10. The optical film of claim 1 wherein the positive birefringence polymeric layers have an out-of-plane birefringence of greater than 0.002 and the negative birefringence polymeric layers have an out-of-plane birefringence of less than −0.002.

11. The optical film of claim 1 wherein the positive birefringence polymeric layers comprise a polymer having off the backbone a non-visible chromophore group.

12. The optical film of claim 11 wherein the non-visible chromophore group includes a heterocyclic or carbocyclic aromatic group.

13. The optical film of claim 11 wherein the non-visible chromophore group includes a carbonyl, halogen, amide, imide, ester, carbonate, phenyl, naphthyl, biphenyl, bisphenol, thiophene, vinyl, aromatic, sulfone, or azo group or combinations thereof.

14. The optical film of claim 1 wherein the negative birefringence polymeric layers comprise a polymer having in the backbone a non-visible chromophore group.

15. The optical film of claim 14 wherein the non-visible chromophore group includes a heterocyclic or carbocyclic aromatic group.

16. The optical film of claim 14 wherein the non-visible chromophore group includes a carbonyl, halogen, amide, imide, ester, carbonate, phenyl, naphthyl, biphenyl, bisphenol, thiophene, vinyl, aromatic, sulfone, or azo, group or combinations thereof.

17. The optical film of claim 1 wherein the negative birefringent polymers comprise polycarbonates, polyesters, polysulfones, polyamides, polyphenylene oxides, polyarylates and blends thereof, and the positive birefringent polymers comprise polystrene, styrene-acrylonitrile copolymers, polyvinyl carbazole, poly vinyl phenol and blends thereof.

18. The optical film of claim 1 wherein the in-plane retardation of the film is from 0 to 300 nm.

19. The optical film of claim 1 wherein the in-plane retardation of the film is from 20 to 200 nm.

20. The optical film of claim 1 wherein the in-plane retardation of the film is from 25 to 100 nm.

21. The optical film of claim 1 wherein the out-of-plane retardation of the film is from −300 to +300 nm.

22. The optical film of claim 1 wherein the out-of-plane retardation of the film is from −200 to +200 nm.

23. The optical film of claim 1 wherein the out-of-plane retardation of the film is from −100 to +100 nm.

24. The optical film of claim 1 wherein the optical film is 10 to 200 microns thick.

25. The optical film of claim 1 wherein the in-plane dispersion parameter of the film is from 0.3 to 1.0.

26. The optical film of claim 1 wherein the in-plane dispersion parameter of the film is from 0.7 to 1.0.

27. The optical film of claim 1 wherein the out-of-plane dispersion parameter of the film is 0.3 to 1.0.

28. The optical film of claim 1 wherein the out-of-plane dispersion parameter of the film is from 0.7 to 1.0.

29. The optical film of claim 1 wherein said film is a compensation film.

30. The optical film of claim 29 wherein said compensation film is a polarizer protective film.

31. The optical film of claim 1 further comprising a plurality of non-birefringent layers.

32. The optical film of claim 1 wherein the overall Δnₜₕ of the film is less negative than −4.0×10⁻³ .

33. A liquid crystal display device comprising the optical film of claim 1.
